(19) United States
(12) Patent Application Publication
(10) Pub. No.: US 2004/0083649 A1
(43) Pub. Date: May 6, 2004

(54) Method of covering a potted plant using a floral sleeve having a hinged inner bottom member

(76) Inventor: Donald E. Weder, Highland, IL (US)

Correspondence Address: DUNLAP, CODDING & ROGERS P.C., PO BOX 16370, OKLAHOMA CITY, OK, 73113, US

(21) Appl. No.: 10/641,390

(22) Filed: Aug. 14, 2003

Related U.S. Application Data
(63) Continuation-in-part of application No. 10/094,739, filed on Mar. 8, 2002, now abandoned.

(51) Int. Cl. A01G 9/02

(52) U.S. Cl. 47/72

(57) ABSTRACT

A floral sleeve sized to contain a pot or floral grouping, the floral sleeve having a rigid bottom member which can be folded down from a flattened position to an open position for forming a rigid bottom in the floral sleeve. The floral sleeve may comprise a detachable upper portion, a skirt portion, a bottom gusset and/or side gussets.

### CROSS REFERENCE TO RELATED APPLICATIONS

The present application is a continuation-in-part of U.S. Ser. No. 10/094,739, filed Mar. 8, 2002, which is hereby expressly incorporated by reference herein in its entirety.

### FIELD OF THE INVENTION

This invention generally relates to floral containers, and, more particularly, to floral sleeves, which are used to contain floral groupings, pots and media, and methods of using same.

### BRIEF DESCRIPTION OF THE DRAWINGS

FIG. 1 is an elevational view of a sleeve having a gusset in each side thereof and having an inner bottom member shown therein in phantom.

FIG. 2 is a perspective view of the sleeve of FIG. 1 partially expanded.

FIG. 3 is a cross-sectional view of the sleeve of FIG. 2, taken along line 3-3 thereof.

FIG. 4 is a cross-sectional view of the sleeve of FIG. 2 taken along line 4-4.

FIG. 5 is a perspective view of the sleeve of FIG. 2 fully expanded and with the inner bottom member unfolded.

FIG. 6 is a perspective view of a sleeve similar to the sleeve of FIG. 1 but having two gussets in each side of the sleeve.

FIG. 7 is an elevational view of another sleeve constructed in accordance with the present invention similar to the sleeve of FIG. 1 yet having a non-linear upper end.

FIG. 8 is a perspective view of a partially expanded sleeve having an upper portion detachable via a line of perforations.

FIG. 9 is an elevational view of a sleeve similar to the sleeve of FIG. 8 but having a non-linear line of perforations.

FIG. 10 is a perspective view of a partially expanded sleeve having a gusset in each side and having a bottom gusset and having an inner bottom member, the bottom gusset being of a different configuration than the bottom gusset of the sleeves in FIGS. 1-9.

FIG. 11 is a perspective view of a partially expanded sleeve similar to the sleeve of FIG. 10 but having a concave lower end.

FIG. 12 is an elevational view of a non-gusseted sleeve having a fold-down inner bottom member shown in phantom.

FIG. 13 is a cross-sectional view of the sleeve of FIG. 12 taken along line 13-13 thereof.

FIG. 14 is a cross-sectional view of the sleeve of FIG. 12 with the inner bottom member unfolded, and the sleeve having a pot disposed therein and resting on the inner bottom member.

FIG. 15 is a perspective view of the sleeve of FIG. 5 containing a potted plant.

FIG. 16 is a cross-sectional view of the sleeve and potted plant of FIG. 15 taken along line 15-15 thereof.

FIG. 17 is a perspective view of the sleeve of FIG. 5 containing a floral grouping.

FIG. 18 is a cross-sectional view of the sleeve and floral grouping of FIG. 17 taken along line 18-18 thereof.

FIG. 19 is a perspective view of the sleeve of FIG. 8 fully expanded with the inner bottom member unfolded and containing a plant and growing medium.

### DESCRIPTION OF THE PREFERRED EMBODIMENTS

The present invention is a floral sleeve (also referred to herein as a “sleeve” or “preformed sleeve”) for covering a flower pot (also referred to herein as pot). The floral sleeve has an upper end, a lower end and an outer peripheral surface. The sleeve may be used as a container for a floral grouping or a potted plant. The sleeve comprises an inner retaining space sized to contain the flower pot, potted plant, floral grouping or medium for containing a plant. The sleeve may also have a skirt portion, optionally, which extends as a portion of the upper end of the sleeve. The sleeve optionally includes one or more expansion elements which preferably are one or more gussets in each sidewall thereof and, optionally, in the skirt portion, where present, and optionally, in an upper portion which is detachable. The sleeve preferably is initially formed in a flattened condition and may be shipped in a flattened condition or may be expanded to an open condition prior to shipment. The sleeve optionally further includes a gusset in the bottom thereof. Each sidewall and the bottom of the sleeve may include more than one gusset therein. A bonding material may be disposed on an inner surface for connecting the sleeve to the flower pot or for crimping portions of the sleeve. The gusset, when present, functions to allow the sleeve to expand to contain the flower pot and to conform to the shape of the outer peripheral surface of the flower pot when the flower pot is disposed within the sleeve. The detachable upper portion, when present, is generally sized to enclose a floral grouping, and which when detached, may allow the skirt portion, if present, to extend when the flower pot or floral grouping is disposed within the sleeve. The upper portion, when present, may be detachable via perforations, tear strips, weakened areas, or zippers. The sleeve may have an area or aperture which serves as a handle or support device. The gussets may extend the entire length from the lower end of the sleeve portion to the upper end of the sleeve or may extend only an intermediate distance therebetween.

The expansion elements are not intended to be limited only to the gussets shown herein, in view of the fact that gussets and their manufacture are well known to those of ordinary skill in the art of manufacturing bags.

The sleeve may form part of a plant package when used in conjunction with the flower pot or potted plant or floral grouping which is disposed within the retaining space of the sleeve, the flower pot having a floral grouping disposed therein, and wherein the flower pot is substantially surrounded and encompassed by a lower portion of the sleeve and the floral grouping is substantially surrounded and enclosed by the upper portion of the sleeve in those embodiments wherein the upper portion forms a part of the sleeve.

Further, the detachable upper portion, when present, may extend from an upper end of the skirt. The upper portion alternatively may be connected to a base portion of the sleeve. It may be connected to an inner portion thereof, leaving the skirt portion exposed, or it may be attached to an outer portion of the sleeve, thereby enclosing the skirt portion until the upper portion is detached from the sleeve thereby exposing the skirt portion.

The sleeve may be constructed from one or more types of material. The sleeve may comprise a portion of a plant package which additionally includes the flower pot disposed within the sleeve, the flower pot having a floral grouping disposed therein, and wherein the flower pot is substantially surrounded and encompassed by all or part of the sleeve. Alternatively, the plant package may comprise only the sleeve, a plant, and a medium for containing the plant, or only a plant (floral grouping).

These embodiments and others of the present invention are now described in more detail below. It will be appreciated that the examples provided herein are not intended to limit the scope and extent of the claimed invention but are only intended to exemplify various of the embodiments of the invention contemplated herein.

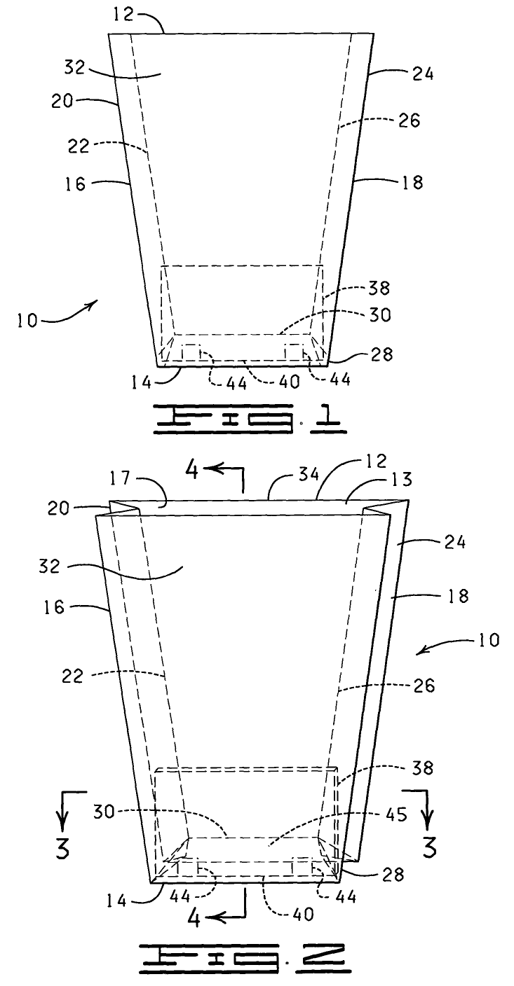

### The Embodiments and Methods of Use of FIGS. 1-11

Shown in FIGS. 1-5, and designated therein by the general reference numeral 10, is a flexible sleeve having a preformed tubular shape. The sleeve 10 is initially formed in a flexible flat or flattened state or condition which is openable in the form of a tube having a closed bottom which may have drainage holes or may be partially open. Prior to shipment to a user, or prior to use by the user, the sleeve 10 can be expanded automatically or manually into an opened configuration (FIG. 5). The sleeve 10 is preferably tapered outwardly from a lower end 14 to a larger diameter at an upper end 12. In the flattened state, the sleeve 10 preferably has an overall trapezoidal or modified trapezoidal shape, and when opened is substantially frusto-conical, or frusto-pyramidal. It will be appreciated, however, that the sleeve 10 may have variations on the aforementioned shapes or may have significantly altered shapes, such as square or rectangular, as long as the sleeve 10 functions in accordance with the present invention in the manner described herein.

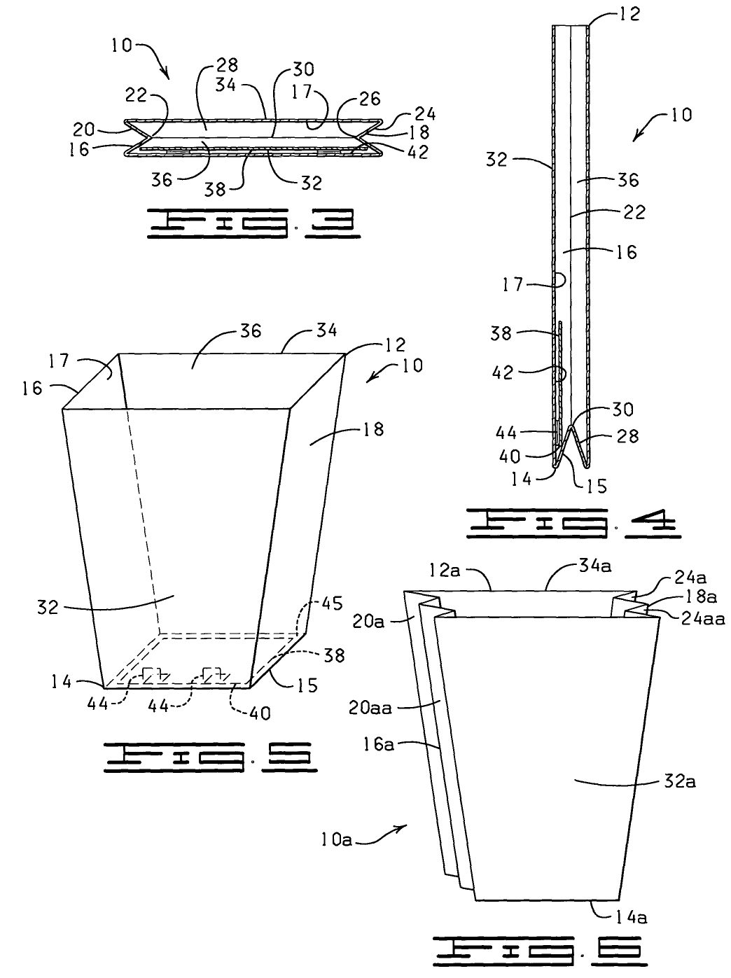

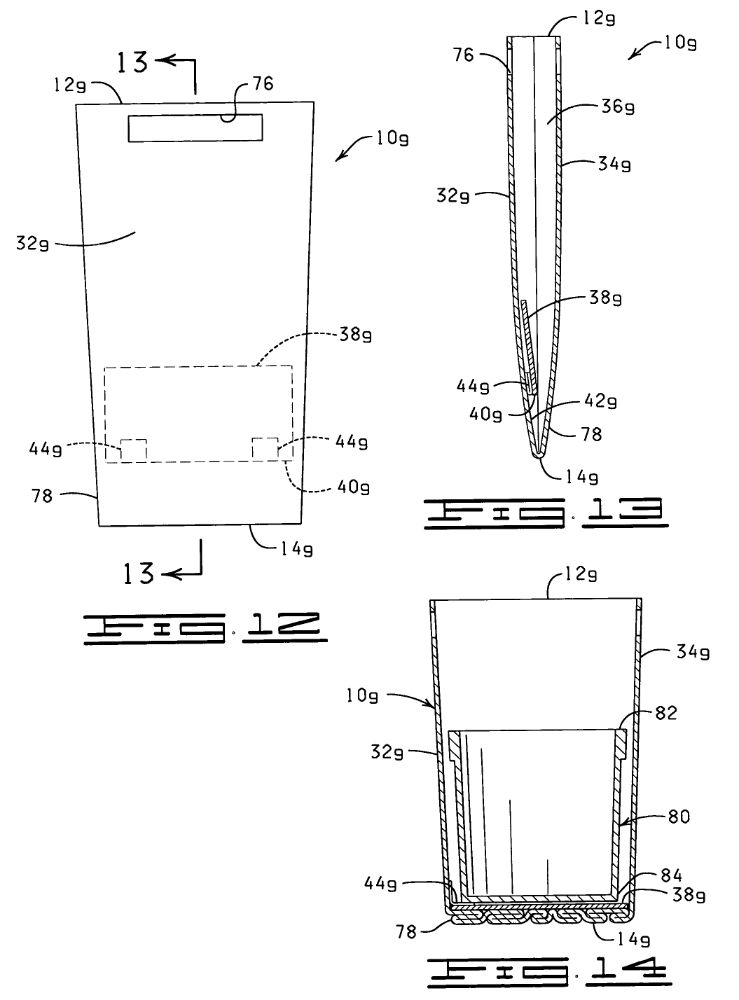

The sleeve 10, in a preferred embodiment, in addition to the upper end 12 and the lower end 14, has a first sidewall 16 which is collapsed and a second sidewall 18 which is collapsed when the sleeve 10 is in the flattened state, as shown in FIG. 1. The sleeve 10 has an opening 13 (FIG. 2) at the upper end 12 and is closed with a bottom 15 (FIGS. 4 and 5) at the lower end 14. The sleeve 10 also has an inner peripheral surface 17 which, when the sleeve 10 is opened, defines and encompasses an inner retaining space 36, as indicated in FIGS. 3-5. The first sidewall 16 includes a first sidewall gusset 20 having an inner fold 22. The second sidewall 18 includes a second sidewall gusset 24 having an inner fold 26. A portion of the lower end 14 of the sleeve 10 is preferably folded to form one or more bottom gussets 28 constructed in a manner well known to one of ordinary skill in the art as shown in FIGS. 1-4, for permitting a bottom of an object such as a potted plant to be disposed into an inner retaining space 36 of the sleeve 10. Each bottom gusset 28 of the sleeve 10 preferably has an inner fold 30, as shown in FIGS. 1-4. The lower end 14 of the sleeve 10, and particularly the bottom gusset 28 therein, may be constructed to form a sleeve having a round bottom in the manner shown in copending U.S. Pat. No. 6,182,395, the specification of which is hereby expressly incorporated herein in its entirety and described herein below in FIG. 11. A sleeve in an alternate embodiment may be constructed without a gusset in its lower end as shown herein below in FIG. 12. In another embodiment, the bottom gusset 28 may be constructed in a different configuration from that shown herein. The sleeve 10 further comprises a first panel 32 disposed between first sidewall 16 and second sidewall 18, and a second panel 34 disposed between first sidewall 16 and second sidewall 18, opposite first panel 32, substantially as shown in FIGS. 2-5.

Further, the sleeve 10 may have any shape, whether geometric, non-geometric, asymmetrical and/or fanciful as long as it functions in accordance with the present invention. The sleeve 10 may also be equipped with a drainage element (e.g., one or more holes) in the lower end 14 thereof or ventilation holes (not shown), or the sleeve 10 can be made from permeable or impermeable materials.

The sleeve 10 has an inner bottom member 38 (also referred to simply as the “bottom member”) which is attached at an end 40 to an inner portion 42 of the first panel 32 preferably via hinges 44. The bottom member 38 therefore is in a vertical position facing the inner peripheral surface 17 of the front sidewall 32 when the sleeve 10 is in the flattened condition, also referred to herein as a storage position, as shown in FIGS. 1-4. FIG. 5 shows sleeve 10 in an open or expanded condition wherein the sleeve 10 is fully expanded in preparation for receiving a pot or floral grouping. In the expanded condition shown in FIG. 5, the bottom member 38 is folded down or extended after the sleeve 10 is expanded, whereby the bottom member 38 is positioned generally at a right angle to the first panel 32 to rest upon an inner surface 45 of the bottom 15 of the sleeve 10. The bottom member 38 provides, in effect, a “floor” for the bottom 15 of the sleeve 10 when in the opened condition.

The bottom member 38 therefore serves to improve the function of the sleeve 10 by (1) providing a scratch-resistant surface on the bottom 15 so a potted plant can rest thereon without scratching the bottom 15, (2) strengthening the bottom 15 so the sleeve 10 can be used to carry a potted plant, (3) enhancing the rigidity of the bottom 15 so the sleeve 10 can stand erect on it's own, to be used, for example as a vase, and/or (4) strengthening the bottom 15 of the sleeve 10 so that moisture from a potted plant disposed therein will not excessively weaken, or will weaken less, the bottom 15.

The bottom member 38 may be constructed of any material having a rigidity appropriate for the invention, including, but not limited to, cardboard, reinforced fabric, plastic, wood, metal, polymer resin, and natural fibers.

FIG. 3 is a cross-sectional view of the sleeve 10 taken along line 3-3 of FIG. 2. The sleeve 10 is partially expanded, showing the bottom member 38 within the inner retaining space 36, as well as the first side gusset 20 with inner fold 22, the second side gusset 24 with inner fold 26, the inner peripheral surface 17 and the inner portion 42 of the first panel 32, and the second panel 34.

FIG. 4 is a cross-sectional view of sleeve 10 showing the bottom member 38 attached by hinges 44 at end 40 to the inner portion 42 of the first panel 32 and vertically oriented within the inner retaining space 36. The bottom gusset 28 having inner fold 30 in the bottom 15 in the lower end 14 is also indicated.

When the sleeve 10 is in the fully open configuration, as shown in FIG. 5, the first sidewall gusset 20 and second sidewall gusset 24 have been expanded to form the first sidewall 16 and second sidewall 18 of the sleeve 10, respectively. Similarly, bottom gusset 28 has been expanded to form the bottom 15, having inner surface 45, of the sleeve 10. Sleeve 10 in FIG. 5 also has first panel 32 and second panel 34. Preferably, the sleeve 10 is sized to contain and conform to one of a variety of standard sizes of flower pots known to those of ordinary skill in the art, such as 4-inch, 6-inch and 8-inch flower pots. As noted above, the sleeve 10 may be used to contain just a floral grouping, or a plant and a growing medium without the use of a flower pot.

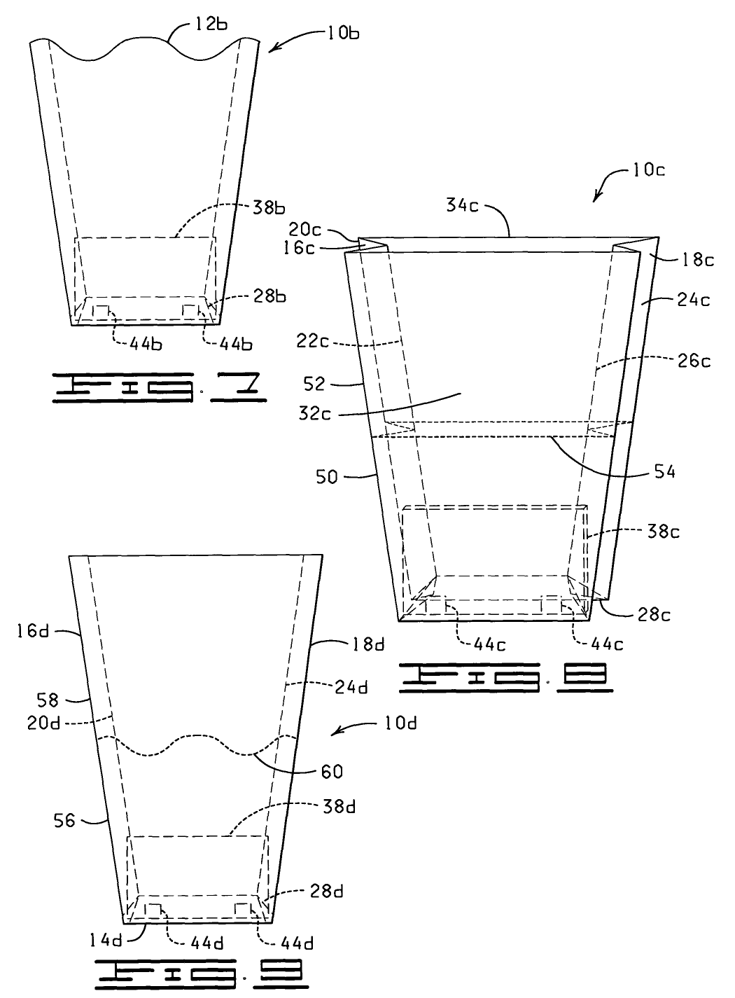

In an alternate embodiment, a sleeve contemplated herein may have more than one side and/or bottom gusset, for example as shown in sleeve 10a in FIG. 6. Sleeve 10a has with an upper end 12a, a lower end 14a, a first sidewall 16a and a second sidewall 18a. The sleeve 10a has two sidewall gussets 20a and 20aa in the first sidewall 16a, and two sidewall gussets 24a and 24aa in the second sidewall 18a. The sleeve 10a further has a first panel 32a and a second panel 34a and has a bottom member (not visible) which can be unfolded to make a bottom such as shown in FIGS. 1-5 for sleeve 10.

FIG. 7 shows a sleeve 10b having a curved, or non-linear, upper end 12b, a bottom gusset 28b, and a bottom member 38b with a hinge 44b. The non-linear upper end 12b may be wavy, sinusoidal, scalloped, crenulate, crenelate, zig-zagged, or toothed, in any regular or irregular pattern.

The invention further contemplates a sleeve 10c as shown in FIG. 8. Sleeve 10c is constructed in a manner similar to any of sleeves 10-10b, except sleeve 10c includes a lower portion 50 and an upper portion 52. The upper portion 52 is detachable from the lower portion 50 via a detaching element 54, such as perforations. The sleeve 10c has a first side gusset 20c having inner fold 22c for forming a first sidewall 16c and a second side gusset 24c having inner fold 26c for forming a second sidewall 18c, a bottom gusset 28c, a first panel 32c, a second panel 34c, and a bottom member 38c with hinges 44c similar to the previously-described sleeves. The term “detaching element,” as used generally herein, means any element, or combination of elements, or features, such as, but not by way of limitation, perforations, tear strips, weakened areas, zippers, and any other devices or elements of this nature known in the art, or any combination thereof, which enable the tearing away or detachment of one object from another. Therefore, while the detaching element 54 is shown in FIG. 8 as perforations, it will be understood by a person of ordinary skill in the art that tear strips, zippers, or any other “detaching elements” known in the art, or any combination thereof, could be substituted therefore and/or used therewith. In a preferred embodiment, the upper portion 52 is sized to substantially enclose a floral grouping, and lower portion 50 is sized to contain and enclose a flower pot which may contain a floral grouping.

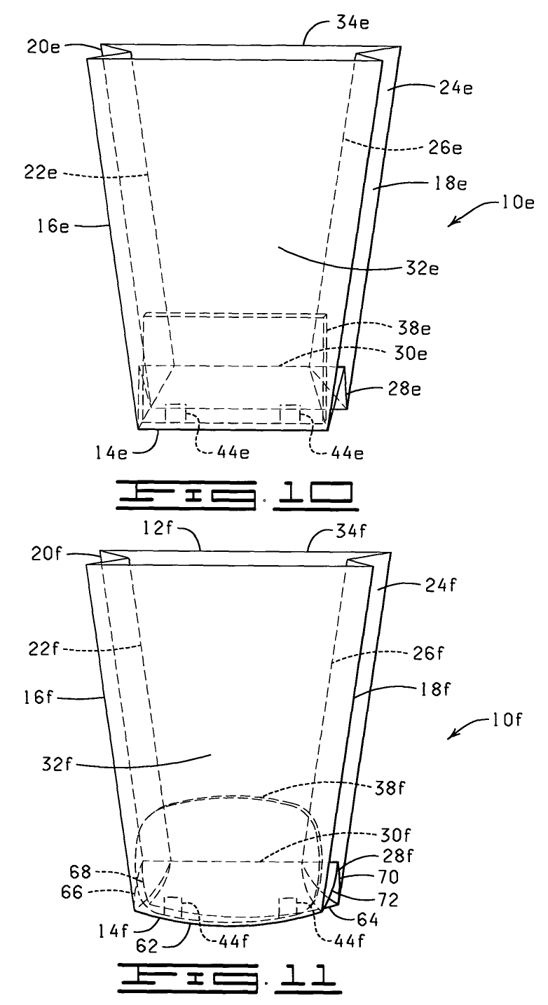

FIG. 9 shows a sleeve 10d which is similar to sleeve 10c except sleeve 10d includes a lower portion 56 and an upper portion 58 which is detachable from the lower portion 56 via a detaching element 60, such as perforations, which has a non-linear pattern. The non-linear pattern of the detaching element 60 may have the same pattern as described above for the upper end 12b of sleeve 10b. Sleeve 10d further includes a first sidewall 16d and a second sidewall 18d, each sidewall 16d and 18d having a sidewall gusset 20d and 24d, respectively, and a bottom 14d with a bottom gusset 28d. Sleeve 10d further comprises a bottom member 38d having hinges 44d similar to sleeves 10-10d previously described.

As noted elsewhere herein, the configurations of the gussets shown in the sleeves 10-10d of FIGS. 1-9 are not the only configurations contemplated for the present invention. Any gusset which functions in accordance with the present invention may be used. For example, FIG. 10 shows a sleeve 10e having a bottom member 38e with hinges 44e, a first panel 32e, second panel 34e, a first sidewall 16e having a first sidewall gusset 20e with an inner fold 22e, and a second sidewall 18e having a second sidewall gusset 24e with an inner fold 26e and a lower end 14e having a bottom gusset 28e with an inner fold 30e. The bottom gusset 28e and inner fold 30e thereof comprises a configuration different from corresponding features of the sleeves 10-10d of FIGS. 1-9. Sleeve 10e, however, functions in essentially the same manner, and is otherwise constructed in the same manner, as the sleeves 10-10d of FIGS. 1-9.

FIG. 11 shows a sleeve 10f which is constructed in a manner similar to that of sleeve 10e in FIG. 10, except for the configuration of a lower end 14f of the sleeve 10f. Sleeve 10f has an upper end 12f, the lower end 14f, a first sidewall 16f with a first sidewall gusset 20f having an inner fold 22f, and a second sidewall 18f with a second sidewall gusset 24f having an inner fold 26f. The lower end 14f has a bottom gusset 28f having an inner fold 30f. The sleeve 10f also has a bottom member 38f having hinges 44f, a first panel 32f and a second panel 34f. The bottom gusset 28f has curved portions 62 and 64 which provide the lower end 14f of sleeve 10f with the appearance of a curve when in the flattened condition. The bottom gusset 28f also has curved portions 66 and 68 in the first sidewall 16f and curved portions 70 and 72 in the second sidewall 18f. The curved portions 62-72 of the bottom gusset 28f provide the sleeve 10f with a rounded bottom when in the open condition for more closely conforming to the rounded configuration of a typical round-bottom flower pot.

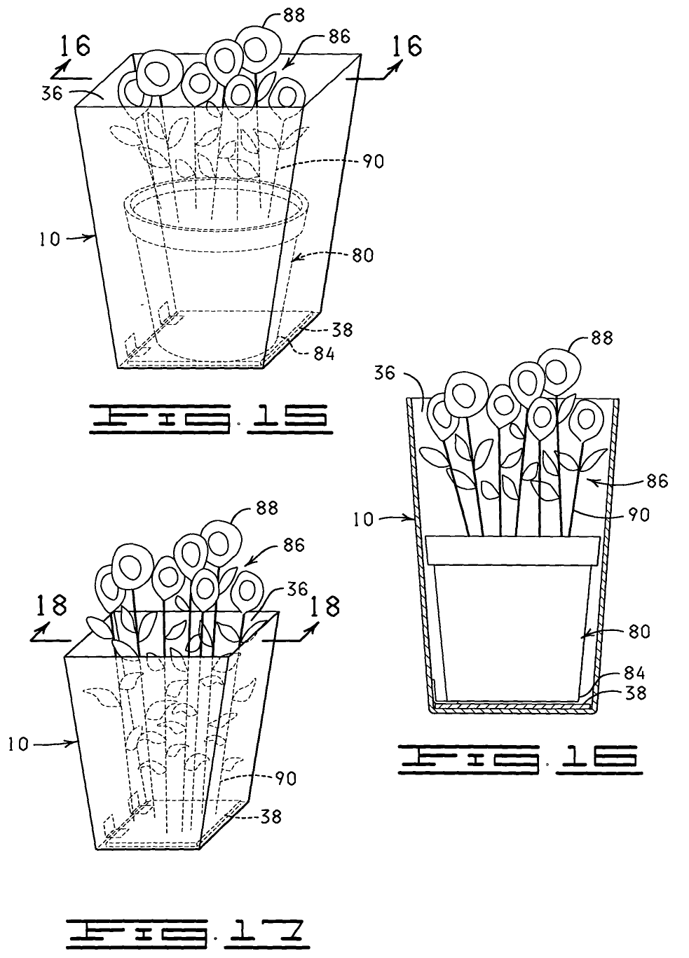

FIGS. 12-14 show a gusset-less alternative sleeve designated by the general reference numeral 10g. Sleeve 10g has an upper end 12g, a lower end 14g, a first panel 32g, a second panel 34g, a bottom member 38g having an end 40g and hinges 44g for attaching the bottom member 38g to an inner portion 42g of the first panel 32g. Sleeve 10g lacks a gusset but has an amount of excess material 78 near the lower end 14g. When the sleeve 10g is opened for deposition of a pot 80 (having an upper end 82 and a lower end 84), the bottom member 38g is folded down, leaving the excess material 78 in a position below the bottom member 38g. When the pot 80 is placed upon the bottom member 38g and placed upon a support surface such as a table (not shown), the excess material 78 is flattened beneath the bottom member 38g as shown in FIG. 14. Sleeve 10g also has a handle 76, shown as an opening near the upper end 12g of the sleeve log. The handle 76 may alternatively be constructed in any manner known in the art, such as a separate string or band attached to the upper end 12g of the sleeve 10g. Further, any of the sleeves 10-10f previously described may be constructed with, or without, a handle such as handle 76.

Any sleeve described herein may be constructed in a manner similar to sleeve 10 wherein a side gusset such as side gusset 20 having an inner fold 22 is tapered to have a lesser width at the lower end 14 and a greater width at the upper end 12. Such a configuration enables the sleeve to have a tapered shape not only in the dimension spanning the first panel 32 and second panel 34, but also in the dimension spanning first sidewall 16 and second sidewall 18.

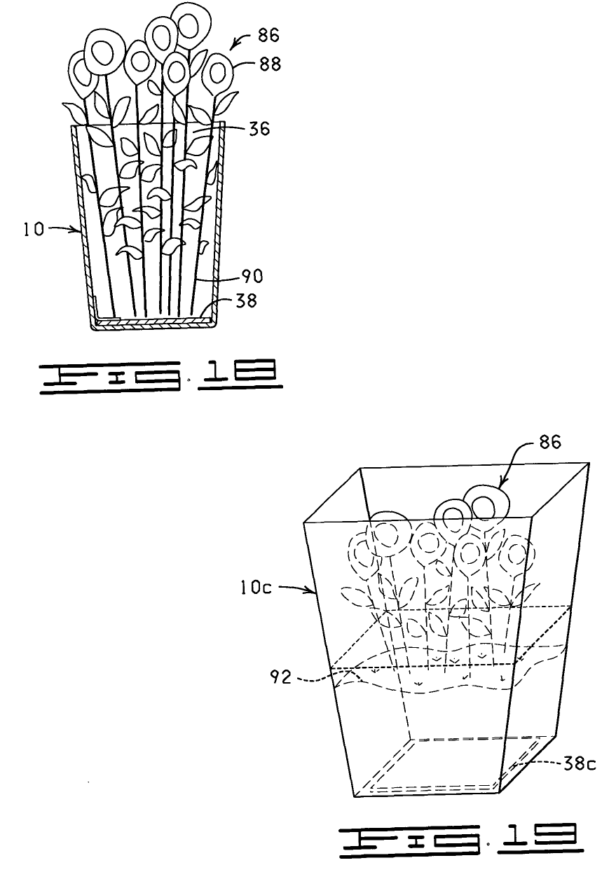

Any of the sleeves 10-10g described herein may be used to contain the pot 80 having a floral grouping 86 (having a stem portion 90 and a bloom portion 88) disposed therein, as shown in FIGS. 15 and 16, where pot 80 is shown as disposed within the inner retaining space 36 of sleeve 10, and the lower end 84 of the pot 80 disposed on the folded-down bottom member 38. Similarly, the sleeve 10 with the folded-down bottom member 38, or any of the other sleeves 10a-10g contemplated herein may be used as a vase to hold a floral grouping 86 with or without liquid within the inner retaining space 36, as shown in FIGS. 17-18. Alternatively, as shown in FIG. 19, a sleeve such as sleeve 10c with folded-down bottom member 38c can be used to contain a floral grouping 86 and a potting or growing medium 92 for displaying or cultivating the floral grouping 86 without a flower pot.

The material from which the sleeves 10-10g are constructed preferably has a thickness in a range from about 0.1 mil to about 30 mils. Often, the thicknesses of the sleeves 10-10g are in a range from about 0.5 mil to about 10 mils. Preferably, each of the sleeves 10-10g has a thickness in a range from about 1.0 mil to about 5 mils. More preferably, the sleeves 10-10g are constructed from a material which is flexible, semi-rigid, rigid, or any combination thereof. The sleeves 10-10g may be constructed of a single layer of material or a plurality of layers of the same or different types of materials. Any thickness of the material may be utilized as long as the material functions in accordance with the present invention and is expandable to an open position as described herein. The layers of material comprising the sleeves 10-10g may be connected together or laminated or may be separate layers. In one embodiment, the sleeves 10-10g may be constructed from a sheet comprising two polypropylene films. In an alternative embodiment, the sleeves 10-10g may be constructed from only one of the polypropylene films. Such materials used to construct the sleeves 10-10g are described in U.S. Pat. No. 5,111,637 entitled “Method For Wrapping A Floral Grouping” issued to Weder et al., on May 12, 1992, which is hereby expressly incorporated herein by reference. Any thickness of material may be utilized in accordance with the present invention as long as the sleeves 10-10g may be formed as described herein, and as long as the formed sleeves 10-10g may contain at least a portion of a pot 80 or a floral grouping 86, as described herein. Additionally, an insulating material such as bubble film, preferably one of two or more layers, can be utilized in order to provide additional protection for the item, such as the floral grouping, contained therein.

The sleeves 10a-10g are constructed from any suitable material that is capable of being formed into a sleeve and wrapped about a flower pot and a floral grouping disposed therein. Preferably, the material is paper (untreated or treated in any manner), metal foil, polymeric film, non-polymeric film, fabric (woven or nonwoven or synthetic or natural), cardboard, fiber, cloth, burlap, or laminations or combinations thereof.

The term “polymeric film” means a synthetic polymer such as a polypropylene or a naturally occurring polymer such as cellophane. A polymeric film is relatively strong and not as subject to tearing (substantially non-tearable), as might be the case with paper or foil.

The material used to construct the sleeves 10-10g may vary in color and may consist of designs or decorative patterns which are printed, etched, and/or embossed thereon using inks or other printing materials. An example of an ink which may be applied to the surface of the material is described in U.S. Pat. No. 5,147,706 entitled “Water Based Ink On Foil And/Or Synthetic Organic Polymer” issued to Kingman on Sep. 15, 1992 and which is hereby expressly incorporated herein by reference.

In addition, the material may have various colorings, coatings, flocking and/or metallic finishes, or other decorative surface ornamentation applied separately or simultaneously or may be characterized totally or partially by pearlescent, translucent, transparent, iridescent, neon, or the like, qualities. The material may further comprise, or have applied thereto, one or more scents. Each of the above-named characteristics may occur alone or in combination and may be applied to an upper and/or lower surface of the material comprising the sleeves 10-10g. Moreover, portions of the material used in constructing the sleeves 10-10g may vary in the combination of such characteristics. The material utilized for the sleeves 10-10g may be opaque, translucent, transparent, or partially clear or tinted transparent.

The term “floral grouping” as used herein means cut fresh flowers, artificial flowers, a single flower or other fresh and/or artificial plants or other floral materials and may include other secondary plants and/or ornamentation or artificial or natural materials which add to the aesthetics of the overall floral grouping. The floral grouping generally comprises a bloom (or foliage) portion and a stem portion. Further, the floral grouping may be a growing potted plant having a root portion (not shown) as well. However, it will be appreciated that the floral grouping may consist of only a single bloom or only foliage, or a botanical item (not shown), or a propagule (not shown). The term “floral grouping” may be used interchangeably herein with both the terms “floral arrangement” and “potted plant”. The term “floral grouping” may also be used interchangeably herein with the terms “botanical item” and/or “propagule.”

The term “growing medium” when used herein means any liquid, solid or gaseous material used for plant growth or for the cultivation of propagules, including organic and inorganic materials such as soil, humus, perlite, vermiculite, sand, water, and including the nutrients, fertilizers or hormones or combinations thereof required by the plants or propagules for growth.

The term “botanical item” when used herein means a natural or artificial herbaceous or woody plant, taken singly or in combination. The term “botanical item” also means any portion or portions of natural or artificial herbaceous or woody plants including stems, leaves, flowers, blossoms, buds, blooms, cones, or roots, taken singly or in combination, or in groupings of such portions such as bouquet or floral grouping.

The term “propagule” when used herein means any structure capable of being propagated or acting as an agent of reproduction including seeds, shoots, stems, runners, tubers, plants, leaves, roots or spores.

In accordance with the present invention, a bonding material may be disposed on a portion of the sleeves 10-10g to assist in holding the sleeves 10-10g to the pot 80 having the floral grouping 86 therein when such a pot 80 is disposed within the sleeves 10-10g or to assist in closing or sealing an upper portion of the sleeves 10-10g or in adhering the sleeves 10-10g to the pot 80 after the pot 80 has been disposed therein; for example, in the manner shown in U.S. Pat. No. 5,493,809, which is hereby expressly incorporated by reference herein in its entirety.

It will be understood that the bonding material may be disposed as a strip or block on a surface of the sleeves 10-10g. The bonding material may also be disposed upon either an outer peripheral surface or an inner peripheral surface of any of the sleeves 10-10g, as well as upon the pot 80. Further, the bonding material may be disposed as spots of bonding material, or in any other geometric, non-geometric, asymmetric, or fanciful form, and in any pattern including covering either the entire inner peripheral surface and/or outer peripheral surface of any of the sleeves 10-10g and/or the pot 80. The bonding material may be covered by a cover or release strip which can be removed prior to the use of the sleeve 10-10g and/or pot 80. The bonding material can be applied by means known to those of ordinary skill in their art. One method for disposing a bonding material, in this case an adhesive, is described in U.S. Pat. No. 5,111,637 entitled “Method For Wrapping A Floral Grouping” issued to Weder et al., on May 12, 1992, which has been expressly incorporated by reference above.

The term “bonding material,” when used herein means an adhesive, frequently a pressure sensitive adhesive, or a cohesive. When the bonding material is a cohesive, a similar cohesive material must be placed on the adjacent surface for bondingly contacting and bondingly engaging with the cohesive material. The term “bonding material” also includes materials which are heat sealable and, in this instance, the adjacent portions of the material must be brought into contact and then heat must be applied to effect the seal. The term “bonding material” also includes materials which are sonic sealable and vibratory sealable. The term “bonding material,” when used herein also means cold sealing adhesive, a heat sealing lacquer or hot melt material which may be applied to the material and, in this instance, heat, sound waves, or vibrations, also must be applied to effect the sealing.

It will be understood by a person of ordinary skill in the art that equipment and devices for forming floral sleeves are commercially available, and are well known to a person of ordinary skill in the art. Therefore, further discussion of the construction of the covers described herein is not deemed necessary.

In one version of the present invention a strip of bonding material (not shown) may be disposed adjacent the upper end of the sleeve for allowing the upper end to be sealed for enclosing the upper portion of the sleeve about a floral grouping disposed therein. In another version of the present invention, a sleeve may comprise a flap positioned at the upper end which can be folded over and sealed with a flap bonding strip to an adjacent portion of the outer peripheral surface of the sleeve near the upper end thereof. Other versions of the sleeve (not shown) may include ventilation holes or drainage means (e.g., holes in the lower end 14) for allowing movement of gases or moisture to and away from the inner space of the sleeve.

In another embodiment, the sleeve may further comprise a portion having apertures therein, which portion comprises or extends away from a portion of the upper end of the sleeve for allowing the sleeve to be supported on a support assembly commercially available and known by one of ordinary skill in the art such as a pair of wickets for shipment, storage, assembly of the sleeve, placement of the flower pot within the sleeve, or other functions known in the art. The extension may have a plurality of perforations or other detaching elements for allowing the extension to be removed from the upper end sleeve after the sleeve has been provided for use as described elsewhere herein. The sleeve may further comprise a detaching element comprising perforations for removing a handle at a later time when the sleeve comprises a handle.

Each side gusset of the sleeve comprises one or more areas of excess material which may have the form of a pleat which extends from the lower end to the upper end of the sleeve. Preferably the surfaces of the facing surfaces of the gussets are substantially unconnected to each other along their lengths.

The side gussets in the sleeve contemplated herein may be constructed in such a way that each side gusset extends completely from the lower end of the sleeve to the upper end of the sleeve, for example as shown in FIG. 1. Alternatively, a sleeve may comprise gussets which extend from the upper end only part of the distance toward the lower end or from the lower end to only the part of the distance toward the upper end.

The term “pot” as used herein refers to any type of container used for holding a floral grouping or plant. Examples of pots, used in accordance with the present invention include, but not by way of limitation, clay pots, wooden pots, plastic pots, foam pots, pots made from natural and/or synthetic fibers, or any combination thereof. The pot is adapted to receive a floral grouping in the inner retaining space. The floral grouping may be disposed within the pot along with a suitable growing medium described in further detail herein, or other retaining medium, such as a floral foam. It will also be understood that the floral grouping, and any appropriate growing medium or other retaining medium, may be disposed in the sleeve without a pot (see FIGS. 17-19).

The sleeves described herein may be formed by advancing two separate webs, one or two webs preformed in the form of a tube, or a single web folded double and sealing the longitudinal sides and bottom of the two facing panels then cutting the sleeve thus formed from the webs or web. Machines which can form sleeves from such single webs or pairs of webs are well within the knowledge of one of ordinary skill in the art.

It should also be noted that for all versions of sleeves described, it may be desirable to have a release material or cover strip covering the adhesive or cohesive bonding material when such a bonding material is disposed on any portion of the sleeve for preventing the bonding material from bonding to another surface until the desired time. Further, in each of the cases described herein wherein a sleeve is applied to a pot, the sleeve may be applied thereto either by depositing the pot downwardly into the inner retaining space of the sleeve, or the sleeve may be brought upwardly about the pot from below the pot.

It should be further noted that various features of the versions of the present invention such as closure bonding areas, support extensions, handles, additional perforations, drainage means, ventilation holes, combinations of material may be used alone or in combination as elements of any of the embodiments described above herein.

Changes may be made in the construction and the operation of the various components, elements and assemblies described herein or in the steps or the sequence of steps of the methods described herein without departing from the spirit and scope of the invention as defined in the following claims.

What is claimed is:

1. A method of containing a pot, potted plant, or floral grouping, comprising:
providing a floral sleeve, the floral sleeve having a tapered shape and comprising;
a first panel, a second panel, an upper end, a lower end, an inner retaining space, and an inner bottom member hingeably connected via a hinge to an inner portion of the first panel, the inner bottom member disposed within the inner retaining space and positioned in a storage position generally facing the first panel when the floral sleeve is in a flattened condition, the floral sleeve further comprising an upper portion which is detachable via a detaching element in the floral sleeve, the upper portion adapted to enable the floral sleeve to be supported from a support assembly or connected together in a pad of said floral sleeves;
opening the floral sleeve from the flattened condition to an opened condition;
hingeably extending the inner bottom member from the storage position to an extended position wherein the inner bottom member forms a rigid or semi-rigid bottom in the floral sleeve; and
disposing a pot, potted plant, or floral grouping into the floral sleeve in the opened condition.

2. The method of claim 1 wherein in the step of providing a floral sleeve, the floral sleeve comprises a bottom gusset in the lower end thereof.

3. The method of claim 1 wherein in the step of providing a floral sleeve, the floral sleeve comprises a first sidewall and a second sidewall positioned between the first panel and the second panel, the first sidewall having a first sidewall gusset therein and the second sidewall having a second sidewall gusset therein.

4. The method of claim 1 wherein in the step of providing a floral sleeve, the floral sleeve comprises a skirt portion.

5. The method of claim 1 wherein in the step of providing a floral sleeve, the floral sleeve comprises a handle.

6. The method of claim 1 wherein in the step of providing a floral sleeve, the detaching element leaves an upper edge in a lower portion of the floral sleeve, the upper edge having a non-linear pattern when the upper portion is detached.

7. The method of claim 1 wherein in the step of providing a floral sleeve, the detaching element leaves an upper edge in a lower portion of the floral sleeve, the upper edge having a linear pattern when the upper portion is detached.

8. The method of claim 1 wherein in the step of providing a floral sleeve, the upper portion is sized to substantially enclose the floral grouping disposed therein.

9. The method of claim 1 wherein in the step of providing the floral grouping, the hinged inner bottom member is constructed from a material selected from the group consisting of cardboard, wood, plastic, metal, reinforced fabric, polymer resin, and natural fibers.
